(19) United States
(12) Patent Application Publication
(10) Pub. No.: US 2020/0064289 A1
(43) Pub. Date: Feb. 27, 2020

(54) SYSTEMS AND METHODS FOR DEFECT DETECTION IN ADDITIVELY MANUFACTURED BODIES

(71) Applicant: ARCONIC INC., Pittsburgh, PA (US)

(72) Inventors: Wei Huang, Mars, PA (US); Michael Globig, New Kensington, PA (US)

(21) Appl. No.: 16/668,844

(22) Filed: Oct. 30, 2019

Related U.S. Application Data
(63) Continuation of application No. PCT/US2018/031669, filed on May 8, 2018.
(60) Provisional application No. 62/503,677, filed on May 9, 2017.

(51) Int. Cl. G01N 25/72; G06T 7/00; G06K 9/62; G06K 9/50

(52) U.S. Cl. CPC G01N 25/72; G06T 7/0004; B33Y 50/02; G06K 9/50; G06K 9/6202

(57) ABSTRACT

Method of detecting defects in an additively manufactured metal part is disclosed. In some embodiments, methods of detecting defects in an additively manufactured metal part include: additively manufacturing each metal layer of a metal body, capturing one or more images of each metal layer, and processing the images to detect potential defect areas in each metal layer.

### CROSS-REFERENCE TO RELATED APPLICATIONS

This application is a continuation of International Patent App. No. PCT/US2018/031669, filed May 8, 2018, which claims benefit of U.S. provisional patent application Ser. No. 62/503,677, filed May 9, 2017, each of which is herein incorporated by reference in its entirety

### FIELD OF THE INVENTION

The present disclosure is directed towards systems and methods of utilizing images obtained during an additive manufacturing (AM) build process and processing the images to extract information indicative of defects detected on the AM part in-situ during the build.

### BACKGROUND

Additive manufacturing may be used to build, via computer control, successive layers of a metal body. Defects in the metal body may occur as a result of the additive manufacturing process.

### SUMMARY OF THE INVENTION

In some embodiments of the disclosure, a method is provided, comprising: heating at least a portion of a first layer of a metal body to form a heated portion of the first layer; capturing a first plurality of thermal digital images of the heated portion of the first layer; stitching the first plurality of thermal digital images into a first stitched thermal digital image of the heated portion of the first layer; heating at least a portion of a second layer of the metal body to form a heated portion of the second layer; capturing a second plurality of thermal digital images of the heated portion of the second layer; stitching the second plurality of thermal digital images into a second stitched thermal digital image of the heated portion of the second layer; applying a local threshold to the first stitched thermal digital image and to the second stitched thermal digital image to generate a respective first binary image and a respective second binary image; multiplying the first binary image by the second binary image to generate a multiplied binary image; and identifying defect areas on the multiplied binary image based on pixel intensity value.

In some embodiments, the method further comprises: prior to multiplying, filtering the first binary image and the second binary image to remove at least a portion of noise in the first binary image and the second binary image.

In some embodiments, the method further comprises: prior to multiplying, dilating the first binary image and the second binary image to generate a dilated first binary image and a dilated second binary image.

In some embodiments, stitching the plurality of thermal digital images into each respective stitched thermal digital image, comprises: applying a global threshold to each respective thermal digital image of the plurality of thermal digital images to generate a corresponding respective binary image; multiplying each corresponding respective binary image by the corresponding respective thermal digital image to generate a respective multiplied thermal digital image; and adding each respective multiplied thermal digital image with a following multiplied thermal digital image to generate the stitched thermal digital image.

In some embodiments, the method further comprises: after generating the stitched thermal digital image, one of: replacing a greyscale value of each pixel in the stitched thermal digital image with a global average intensity value when the greyscale value of the pixel is above a global threshold value, or keeping the greyscale value of each pixel in the stitched thermal digital image when the greyscale value of the pixel is below a global threshold value.

In some embodiments, the method further comprises: prior to applying a global threshold to generate a corresponding respective binary image, applying an averaging filter to each respective thermal digital image of the plurality of thermal digital images to remove at least a portion of noise from each respective thermal digital image.

In some embodiments, the method further comprises: prior to multiplying each corresponding respective binary image by the corresponding respective thermal digital image, dilating each corresponding respective binary image.

In some embodiments, the method further comprises: removing particles of a predetermined size from each corresponding respective dilated binary image.

In some embodiments, the method further comprises: prior to applying a local threshold to the first stitched thermal digital image and to the second stitched thermal digital image, eliminating perspective distortion from each respective stitched thermal digital image.

In some embodiments, each of the first plurality of thermal digital images and each of the second plurality of thermal digital images is exposed for a sufficient time to capture each of the first plurality of thermal digital images and each of the second plurality of thermal digital images without saturating the respective thermal digital image.

In some embodiments, each of the first plurality of thermal digital images and each of the second plurality of thermal digital images is captured via a system comprising: an imaging device having a lens; a neutral density filter attached to the imaging device lens; a notch filter attached to the neutral density filter; and a near-infrared band pass filter attached to the notch filter.

In some embodiments, a method comprises: heating at least a portion of a first layer of a metal body to form a heated portion of the first layer; capturing a first plurality of thermal digital images of the heated portion of the first layer; stitching the first plurality of thermal digital images into a first stitched thermal digital image of the heated portion of the first layer; heating at least a portion of a second layer of a metal body to form a heated portion of the second layer; capturing a second plurality of thermal digital images of the heated portion of the second layer; stitching the second plurality of thermal digital images into a second stitched thermal digital image of the heated portion of the second layer; applying a local threshold to the first stitched thermal digital image and to the second stitched thermal digital image to generate a respective first binary image and a respective second binary image; filtering the first binary image and the second binary image to remove at least a portion of noise in each respective binary image to generate a first filtered binary image and a second filtered binary image; dilating the first filtered binary image and the second filtered binary image to generate a dilated, filtered first binary image and a dilated, filtered second binary image; multiplying the first dilated, filtered binary image by the second dilated, filtered binary image to generate a multiplied binary image; and identifying defect areas on the multiplied binary image based on pixel intensity value.

In some embodiments, stitching the plurality of thermal digital images into each respective stitched thermal digital image, comprises: applying an averaging filter to each respective thermal digital image of the plurality of thermal digital images to remove at least a portion of noise from each respective thermal digital image; applying a global threshold to each respective thermal digital image of the plurality of thermal digital images to generate a corresponding respective binary image; dilating each corresponding respective binary image; removing particles of a predetermined size from each corresponding respective dilated binary image; multiplying each corresponding respective binary image by the corresponding respective thermal digital image to generate a respective multiplied thermal digital image; and adding each respective multiplied thermal digital image with a following multiplied thermal digital image to generate the stitched thermal digital image.

In some embodiments, the method further comprises: after generating the stitched thermal digital image, one of: replacing a greyscale value of each pixel in the stitched thermal digital image with a global average intensity value when the greyscale value of the pixel is above a global threshold value, or keeping the greyscale value of each pixel in the stitched thermal digital image when the greyscale value of the pixel is below a global threshold value.

In some embodiments, a system for detecting defects in an additively manufactured metal part, comprises: an imaging device having a lens; and an image processing system configured to: receive, from the imaging device, a first plurality of thermal digital images of a heated portion of a first layer of a metal body, stitch the first plurality of thermal digital images into a first stitched thermal digital image of the heated portion of the first layer, receive, from the imaging device, a second plurality of thermal digital images of a heated portion of a second layer of the metal body, apply a local threshold to the first stitched thermal digital image and to the second stitched thermal digital image to generate a respective first binary image and a respective second binary image, filter the first binary image and the second binary image to remove at least a portion of noise in each respective binary image to generate a first filtered binary image and a second filtered binary image, dilate the first filtered binary image and the second filtered binary image to generate a dilated, filtered first binary image and a dilated, filtered second binary image, multiply the first dilated, filtered binary image by the second dilated, filtered binary image to generate a multiplied binary image, and identify defect areas on the multiplied binary image based on pixel intensity value.

In some embodiments, the system further comprises: a neutral density filter attached to the imaging device lens; a notch filter attached to the neutral density filter; and a near-infrared band pass filter attached to the notch filter.

In some embodiments, the image processing system is configured to stitch the plurality of thermal digital images into each respective stitched thermal digital image, via: applying an averaging filter to each respective thermal digital image of the plurality of thermal digital images to remove at least a portion of noise from each respective thermal digital image; applying a global threshold to each respective thermal digital image of the plurality of thermal digital images to generate a corresponding respective binary image; dilating each corresponding respective binary image; removing particles of a predetermined size from each corresponding respective dilated binary image; multiplying each corresponding respective binary image by the corresponding respective thermal digital image to generate a respective multiplied thermal digital image; and adding each respective multiplied thermal digital image with a following multiplied thermal digital image to generate the stitched thermal digital image.

### BRIEF DESCRIPTION OF THE DRAWINGS

Embodiments of the present invention, briefly summarized above and discussed in greater detail below, can be understood by reference to the exemplary embodiments of the invention depicted in the appended drawings. It is to be noted, however, that the appended drawings illustrate only exemplary embodiments of this invention and are therefore not to be considered limiting of its scope, for the invention may admit to other equally effective embodiments.

FIG. 1 is a flow diagram of an exemplary method for detecting defect areas in a metal body in accordance with some embodiments of the present invention.

FIG. 2 is a flow diagram of an exemplary method for generating a stitched thermal digital image in accordance with some embodiments of the present invention.

FIGS. 3A-3H depicts exemplary stages of a method for detecting defect areas in a metal body in accordance with some embodiments of the present invention.

FIG. 4 depicts an exemplary system for detecting defect areas in a metal body in accordance with some embodiments of the present invention.

To facilitate understanding, identical reference numerals have been used, where possible, to designate identical elements that are common to the exemplary figures. The exemplary figures are not drawn to scale and may be simplified for clarity. It is contemplated that elements and features of one embodiment may be beneficially incorporated in other embodiments without further recitation.

### DETAILED DESCRIPTION OF THE INVENTION

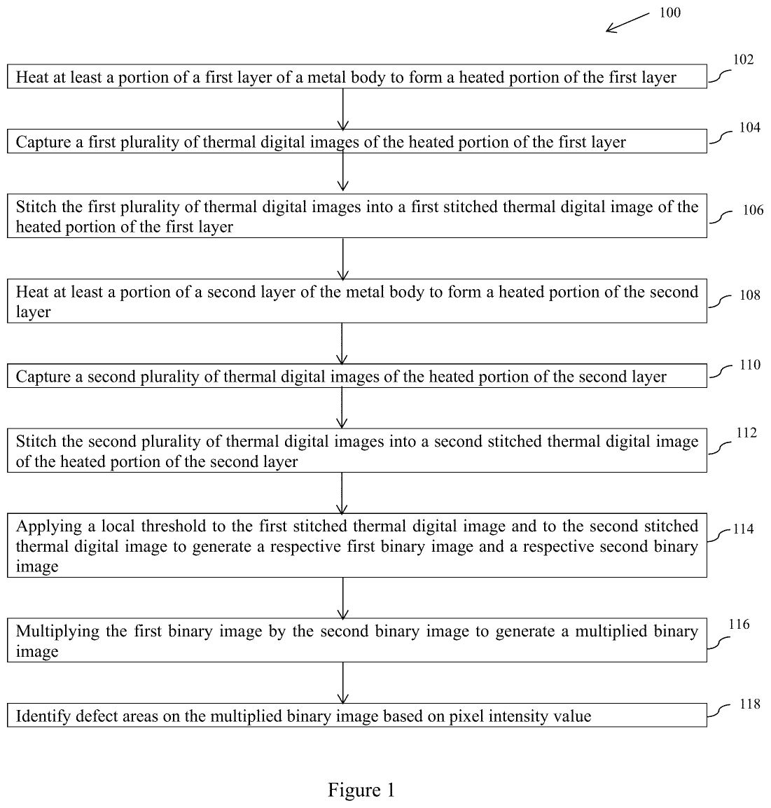

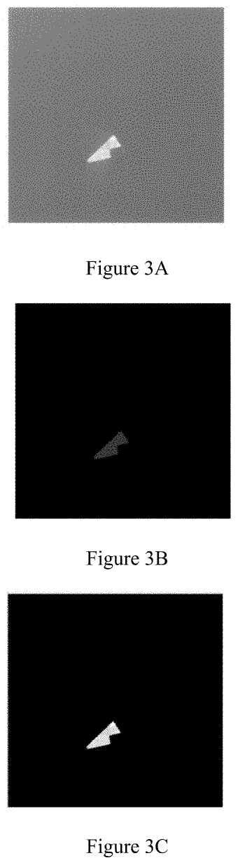

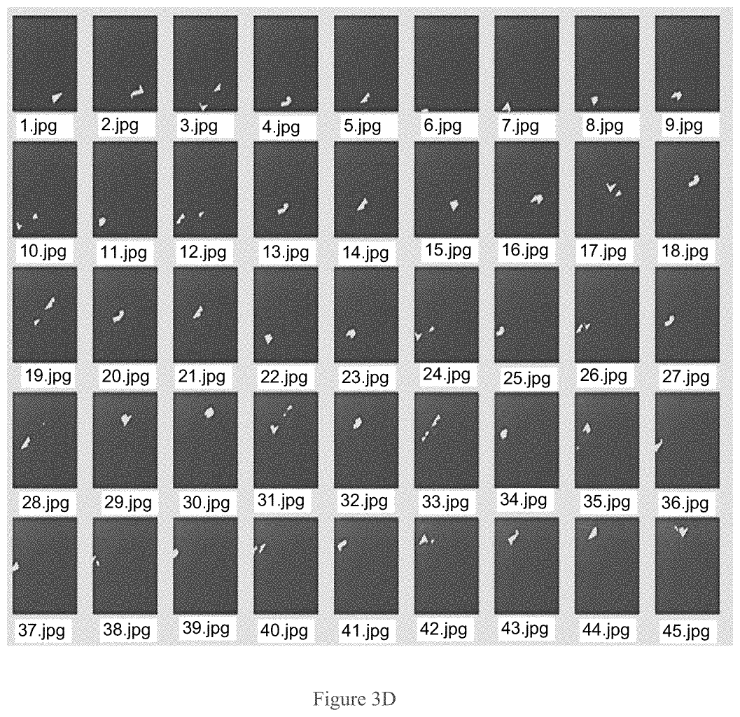

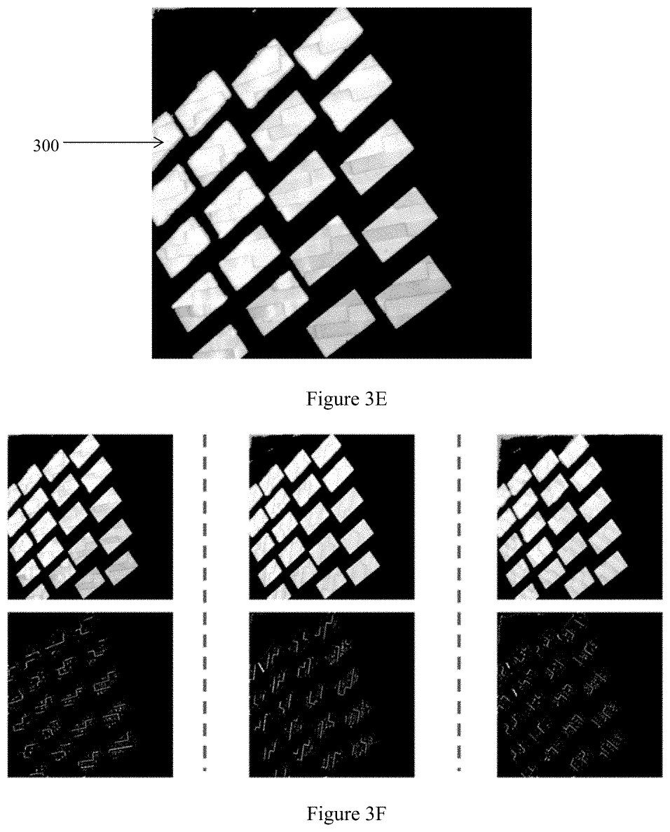

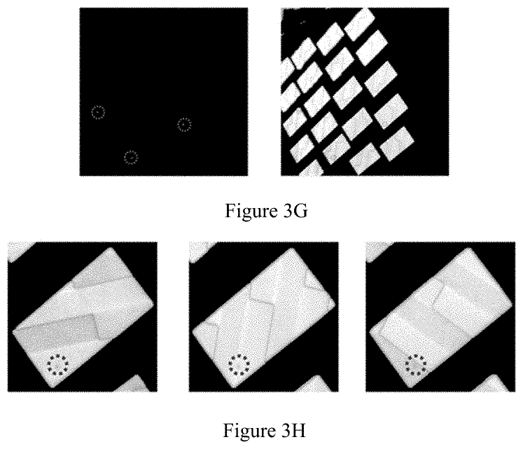

FIG. 1 is a flow diagram of an exemplary method 100 for detecting defect areas in, for example, an additively manufactured metal body, in accordance with some embodiments of the present invention. FIGS. 3A-3H depict exemplary stages of the method 100 for detecting defect areas in, for example, an additively manufactured metal body in accordance with some embodiments of the present invention.

As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. In one embodiment, a method of making an additively manufactured body includes the steps of: (a) selectively heating at least a portion of an additive manufacturing feedstock (e.g., via an energy source or laser) to a temperature above the liquidus temperature of the particular body to be formed, thereby forming a molten pool, and (b) cooling the molten pool thereby forming a solidified mass.

In another embodiment, a method of making an additively manufactured product includes the steps of: (a) dispersing an additive manufacturing feedstock (e.g., a metal powder) in a bed (or other suitable container), (b) selectively heating at least a portion of the additive manufacturing feedstock (e.g., via an energy source or laser) to a temperature above the liquidus temperature of the particular body to be formed, thereby forming a molten pool, and (c) cooling the molten pool thereby forming a solidified mass. In one embodiment, the cooling comprises cooling at a rate of at least 1000° C. per second. In another embodiment, the cooling rate is at least 10,000° C. per second. In yet another embodiment, the cooling rate is at least 100,000° C. per second. In another embodiment, the cooling rate is at least 1,000,000° C. per second. Steps (a)-(c) may be repeated as necessary until the product is completed, i.e., until the final additively manufactured product is formed/completed.

In some embodiments the additive manufacturing feedstock is comprised of one or more powders. In this regard, the powder(s) used to create the final additively manufactured product may be of any suitable composition, including any combination of metallic, alloy, grain refiner materials, and non-metallic (e.g., ceramic material) powders. For instance, any combination of metallic powders, alloy powders, grain refiner materials, and/or non-metallic powders may be used to realize an aluminum alloy composition described above.

Some non-limiting examples of suitable additive manufacturing systems include the EOSINT M 280 Direct Metal Laser Sintering (DMLS) additive manufacturing system, available from EOS GmbH (Robert-Stirling-Ring 1, 82152 Krailling/Munich, Germany). Other suitable additive manufacturing systems include Selective Laser Sintering (SLS) systems, Selective Laser Melting (SLM) systems, and Electron Beam Melting (EBM) systems, among others.

As used herein, “applying an averaging filter” refers to a digital filtering technique which replaces the intensity value of a center pixel value with the average intensity value of all the pixels in a given kernel (e.g., a matrix of numbers that is used in image convolutions).

As used herein, a “binary image” refers to a digital image comprised of binary pixels.

As used herein “binary pixels” are pixels whose intensity values are limited to one of two possibilities. In some embodiments, binary pixels may be pixels whose intensity values are limited to 1 and 0. In some embodiments, binary pixels may be referred to as “on-pixels” and “off-pixels”. In some embodiments, an “on-pixel” is a pixel whose intensity value is 1 (e.g., a white pixel). In some embodiments, an “off-pixel” is a pixel whose intensity value is 0 (e.g., a black pixel).

As used herein, “defect areas” are areas that can cause an inadequacy or failure (e.g. imperfections, aberrations, or deficiencies) in an object (e.g. a metal body). In some embodiments, defect areas are areas having a thermal emission that is lower than the thermal emission of an adjacent area on a layer of the metal body.

As used herein, “dilation” means expanding (i.e., switching off-pixels to on-pixels at the edges of) the particles in a binary image. An exemplary dilation operation may use a structuring element (e.g., a 3×3 or 5 by 5 square of pixels) for expanding such particles.

As used herein, the term “dynamic range” refers to the tonal difference between the lightest light and darkest dark of an image. The higher the dynamic range, the more potential shades can be represented, although the dynamic range does not automatically correlate to the number of tones reproduced. The dynamic range can be represented by the peak greyscale value (i.e. the largest greyscale value) in the image divided by the smallest greyscale value in the image. For example, a raw greyscale image consists of pixels with intensity values from 0 to 255, where 0 is black and 255 is white and wherein the largest greyscale value cannot exceed 255.

As used herein, “metal body” refers to an additively manufactured part. In some embodiments, the metal body may be of any suitable composition, including any combination of metallic, alloy, grain refiner materials, and non-metallic (e.g., ceramic material). For instance, any combination of metallic, alloy, grain refiner, and/or non-metallic materials may be used to realize the metal body described above.

As used herein, “noise” refers to a random variation of brightness or color information in an image.

As used herein, “saturation” refers to the loss of intensity information that occurs when the signal intensity of pixels in an image goes above or below the end of the intensity value scale. For example, a raw greyscale image consists of pixels with intensity values from 0 to 255. If the exposure time of the image is too long, the image will be oversaturated resulting in the loss of intensity information. If the exposure time is too short, the image will have too much noise.

As used herein, a “particle” is a group of contiguous on-pixels in a binary image.

In some embodiments of the disclosure, the method 100 comprises heating at least a portion of a first layer of a metal body to form a heated portion of the first layer and capturing a first plurality of thermal digital images of the heated portion of the first layer (e.g. FIGS. 1, 102 and 104). Subsequently, a second plurality of thermal digital images is captured of a heated portion of a second layer of the metal body (e.g. FIGS. 1, 108 and 110). In some embodiments, the second layer is adjacent the first layer. In some embodiments, the first layer is not the first layer of the metal body formed, for example, by an additive manufacturing process. In some embodiments, the first layer is the beginning layer from which the metal body is examined for defect areas.

The plurality of thermal digital images is captured by an exemplary system described below. FIG. 3A depicts an exemplary thermal digital image of a heated portion of a layer of a metal body. FIG. 3D depicts a plurality of exemplary thermal digital images of at least a heated portion of a single layer. In some embodiments, the thermal digital image is an image capture of specific wavelengths of thermal emissions from the heated portion of the layer. In some embodiments, the practical wavelengths of thermal emissions from the heated portion of the layer range from 700 nm to 1 mm. In some embodiments, each of the plurality of thermal digital images has a plurality of pixels. In some embodiments, each pixel has a specific intensity value. In some embodiments, the plurality of thermal digital images is captured by one or more imaging devices. In some embodiments, the one or more imaging devices are digital cameras or video cameras. In some embodiments, the digital camera is a charged coupled device (CCD) camera. In some embodiments, the digital camera is a complementary metal-oxide semiconductor (CMOS) camera.

In some embodiments, each of the plurality of thermal digital images is exposed for a sufficient amount of time to capture the thermal emissions from the heated portion of the layer without oversaturating the image. In some embodiments, each of the plurality of thermal digital images is exposed for a sufficient time to obtain a suitable dynamic range and suitable signal to noise ratio without saturation of the image. In some embodiments, the sufficient amount of exposure time can be dependent on factors such as the optical equipment used with the camera (e.g. narrowband filters, neutral density filters), the emissivity of the powders, and the additive manufacturing process parameters (e.g. a high temperature/high energy process can saturate the image).

In some embodiments, a sufficient amount of exposure time is 3 to 8 seconds. In some embodiments, a sufficient amount of exposure time is 4 to 8 seconds. In some embodiments, a sufficient amount of exposure time is 5 to 8 seconds. In some embodiments, a sufficient amount of exposure time is 6 to 8 seconds. In some embodiments, a sufficient amount of exposure time is 7 to 8 seconds.

In some embodiments, a sufficient amount of exposure time is 3 to 7 seconds. In some embodiments, a sufficient amount of exposure time is 3 to 6 seconds. In some embodiments, a sufficient amount of exposure time is 3 to 5 seconds. In some embodiments, a sufficient amount of exposure time is 3 to 4 seconds.

In some embodiments, all of the thermal digital images captured can be exposed for the same amount of time for purposes of consistency. In some embodiments, all of the thermal digital images captured in a single layer can be exposed for the same amount of time for purposes of consistency. In some embodiments, all of the thermal digital images captured in a single part build can be exposed for the same amount of time for purposes of consistency. In some embodiments, all of the thermal digital images captured in a single layer can be exposed for the same amount of time, while images in different layers are exposed for different times.

The first plurality of thermal digital images is stitched into a first stitched thermal digital image of the heated portion of the first layer (e.g. FIG. 1, 106). The second plurality of thermal digital images is stitched into a second stitched thermal digital image of the heated portion of the second layer (e.g. FIG. 1, 112). In some embodiments, an n^{th} plurality of thermal digital images of a heated portion of an n^{th} layer of the metal body is captured and stitched into an n^{th} stitched thermal digital image of the heated portion of the n^{th} layer. In some embodiments, the n^{th} layer is the final layer in the formation of the metal body. In some embodiments, the n^{th} layer is the final layer examined for the presence of defect areas. FIG. 3E is an exemplary depiction of a stitched thermal image to show a part build layer 300.

In some embodiments of the method 100, a local threshold (e.g. a Niblack local thresholding algorithm) is applied to the first stitched thermal digital image to generate a first binary image and the local threshold is applied to the second stitched thermal digital image to generate a second binary image (e.g. FIG. 1, 114). In some embodiments, the local threshold is applied to the n^{th} stitched thermal digital image to generate an n^{th} binary image. In some embodiments, the local threshold is calculated for each pixel on the stitched thermal digital image based on local statistics such as range, variance or surface fitting parameters of the neighborhood pixels within a local block of pixels on the stitched thermal digital image.

In some embodiments of the method 100, the first binary image is multiplied by the second binary image to generate a multiplied binary image (e.g. FIG. 1, 116). Multiplying the first binary image by the second binary image refers to multiplying the intensity value of each pixel in the first binary image with the intensity value of the pixel in the corresponding location in the second binary image, thereby producing a multiplied binary image. The multiplied binary image comprises pixels whose intensity values are limited to 1 and 0. Pixels having an intensity value of 1 are identified as defect areas.

In some embodiments, the first binary image and the second binary image are filtered, prior to multiplying, to remove at least a portion of noise in the first binary image and the second binary image. In some embodiments, noise from each respective binary image is reduced or eliminated by applying an averaging filter to each of the respective binary images.

In some embodiments, the first binary image and the second binary image are dilated prior to multiplying the first binary image by the second binary image. In some embodiments, the first binary image and the second binary image are filtered and dilated prior to multiplying the first binary image by the second binary image. In some embodiments, the n^{th} binary image is filtered prior to multiplying. In some embodiments, the n^{th} binary image is dilated prior to multiplying.

In some embodiments, the defect areas of the metal body are identified from the multiplied binary image (e.g. FIG. 1, 118). In some embodiments, the defect areas are identified as areas having a pixel intensity value of 1 (e.g. “local features”) on, for example the multiplied binary image of three consecutive powder build layers as shown in FIG. 3F. FIG. 3G shows potential defect areas (circled areas) detected on a layer based on repeated local features detected in consecutive layers. FIG. 3H is a detailed view of one detected potential defect on three consecutive layers at the same location on the additively manufactured part.

In some embodiments, following identification of the defect areas of the metal body, a response is generated by an exemplary system for detecting defects in an additively manufactured metal part. In some embodiments, the exemplary system is additive manufacturing process chamber or a control system of an additive manufacturing process chamber. In some embodiments, the response is to remove and discard the metal body from the additive manufacturing process chamber if the defect area is uncorrectable. In some embodiments, the response is to correct the defect area of the metal body.

In some embodiments of the method 100, prior to applying a local threshold to the each respective stitched thermal digital image, perspective distortion from the stitched thermal digital image is eliminated. The perspective distortion may be due to the position and view angle of the one or more imaging device relative to the layer. As such, the imaging device, such as a digital camera, can have perspective distortion as compared to the machine perspective and to each other. In some embodiments, the imaging device is calibrated to reduce and/or eliminate perspective distortion. The stitched thermal digital image is adjusted into a corrected stitched thermal digital image such that the location of each image pixel is related to a respective location in the powder bed. A perspective distortion correction algorithm is used to remove perspective distortion.

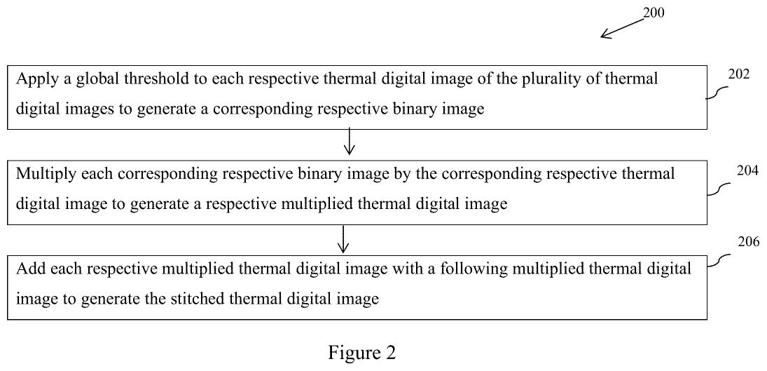

FIG. 2 depicts an exemplary method 200 of stitching the plurality of thermal digital images (e.g. into a first stitched thermal digital image, second stitched thermal digital image, and n^{th} stitched thermal digital image). In some embodiments, a global threshold is applied to each respective thermal image of the plurality of thermal images (e.g. first plurality of thermal images, second plurality of thermal images, n^{th} plurality of thermal images) to generate a corresponding respective binary image. For example, a global threshold is applied to a first thermal image, second thermal image, and n^{th} thermal image of a first plurality of thermal images to generate a corresponding first binary image, second binary image, and n^{th} binary image. FIG. 3B depicts an exemplary binary image generated from an exemplary thermal digital image (e.g. FIG. 3A) of a heated portion of a layer of a metal body. A corresponding binary image is obtained from each of the thermal digital images by comparing each pixel in the thermal digital image to a global threshold in order to binarize each pixel. For example, if the intensity of the pixel is greater than the global threshold value, the intensity of that pixel is replaced by 1. If the intensity of the pixel is not greater than the global threshold value then the intensity of that pixel is replaced by 0. The global threshold value is dependent on factors such as the optical equipment used with the camera (e.g. narrowband filters, neutral density filters), the emissivity of the powders, and the additive manufacturing process parameters (e.g. a high temperature/high energy process can saturate the image).

Each corresponding respective binary image is multiplied by the corresponding respective thermal digital image to generate a respective multiplied thermal digital image. FIG. 3C depicts an exemplary thermal digital image recovered after thresholding and processing. For example, the first binary image is multiplied by the first thermal image, the second binary image is multiplied by the second thermal image, and the n^{th} binary image is multiplied by the n^{th} thermal image of a first plurality of thermal images to generate a corresponding first multiplied thermal digital image, second multiplied thermal digital image, and n^{th} multiplied thermal digital image. In some embodiments, “multiplying each corresponding respective binary image by the corresponding respective thermal digital image” refers to multiplying the intensity value of each pixel in the binary image with the intensity value of the pixel in the corresponding location in the corresponding thermal digital image, thereby producing a multiplied thermal digital image.

Each respective multiplied thermal digital image is added with a subsequent multiplied thermal digital image to generate a stitched thermal digital image. For example, the first multiplied thermal digital image is added with the second multiplied thermal digital image and the n^{th} multiplied thermal digital image to generate the stitched thermal digital image. As used here, in the context of image processing, “adding” refers to, for example, adding the pixel intensity at a first location on a first digital image with the pixel intensity at the same location of a second digital image.

In some embodiments, the exemplary method 200 of stitching the plurality of thermal comprises: prior to applying a global threshold to generate a corresponding respective binary image, eliminating noise, or in some embodiments reducing noise, from each respective thermal digital image of the plurality of thermal digital images. In some embodiments, noise from each respective thermal digital image is reduced or eliminated by applying an averaging filter to each of the plurality of thermal digital images.

In some embodiments, the exemplary method 200 of stitching the plurality of thermal comprises: prior to multiplying each corresponding respective binary image by the corresponding respective thermal digital image, dilating each corresponding respective binary image. In some embodiments, the corresponding respective binary image can include particles, some of which depict defects areas and some which are a result of noise in the digital image. Particles of a predetermined size representative of noise in the digital image are removed from each corresponding respective dilated binary image. In some embodiments, particles having a particle area below a threshold area are removed from the image.

In some embodiments, after generating the stitched thermal digital image, a greyscale value of each pixel in the stitched thermal digital image is replaced with a global average intensity value when the greyscale value of the pixel is above a global threshold value. If the greyscale value is below the global threshold value, the greyscale value of the pixel is retained. As used herein, a “global average intensity value” means the average intensity value of all of the pixels of a digital image. In some embodiments, the global threshold value for converting a greyscale image to a binary image can be tailored depending on the additive manufacturing build parameters, processes or part specifications that are specific to the end use applications of the additively manufactured part. For example, in some embodiments, the global average intensity value is 225 and the global threshold value is 255.

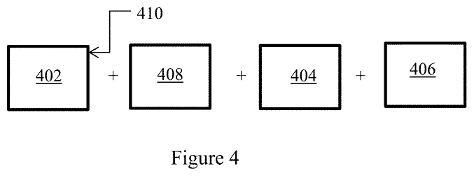

FIG. 4 depicts an exemplary system for detecting defects in an additively manufactured metal part. In some embodiments, the system is utilized in conjunction with an additive manufacturing process chamber. In some embodiments, the additive manufacturing process chamber comprises a processing volume wherein the additively manufactured part is produced. In some embodiments, the system 400 comprises one or more imaging devices 402 for capturing thermal digital images of at least a portion of the powder bed within the processing volume. In some embodiments, the imaging device 402 is a CCD camera or CMOS camera. In some embodiments, the system 400 further comprises a neutral density band pass filter 408. In some embodiments, the neutral density band pass filter 408 is selected to reduce the intensity of visible wavelengths over a broad spectral range via reflection of absorption. In some embodiments, the neutral density band pass filter 408 is attached to the lens of the imaging device 402. In some embodiments, the system 400 further comprises a notch filter 404. In some embodiments, the notch filter 404 is selected to block the wavelength of the additive manufacturing laser to allow the imaging device to capture the thermal emission from the melted powder pool. In some embodiments, the notch filter 404 is attached to the neutral density band pass filter 408. In some embodiments, the neutral density band pass filter 408 is between the imaging device and the notch filter. In some embodiments, the system 400 further comprises a near-infrared band pass filter 406. In some embodiments, the near-infrared band pass filter 406 is selected to allow transmission of specific predetermined near-infrared (NIR) spectral bands while blocking out-of-band signals at higher and lower wavelengths. In some embodiments, the near-infrared band pass filter 406 is attached to the notch filter 404. In some embodiments, the notch filter 404 is between the neutral density band pass filter 408 and the near-infrared band pass filter 406. In some embodiments, the choice of the near-infrared band pass filter is based on the emission of the powder used and the temperature range of the melt pool in the additive manufacturing process.

In some embodiments, the system 400 further comprises an image processing system. In some embodiments, the image processing system is configured to perform the method 100 described above. In some embodiments, the image processing system is an electronic data storage location, where each of the plurality of thermal digital images is saved. In some embodiments, the image processing system is a computer/control system (processor and/or memory), which includes any such computing device capable of sending and receiving information/messages (e.g. over a network, to and from other computing devices (e.g. servers, etc.). In some embodiments, computing devices include laptops, personal computers, multiprocessor systems, microprocessor-based systems; network PCs, and/or programmable consumer electronics (e.g. cameras). In some embodiments, the computer/control system can be configured wirelessly or with wires to enable communication between components and/or other computing devices.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

We claim:

1. A method, comprising:
heating at least a portion of a first layer of a metal body to form a heated portion of the first layer;
capturing a first plurality of thermal digital images of the heated portion of the first layer;
stitching the first plurality of thermal digital images into a first stitched thermal digital image of the heated portion of the first layer;
heating at least a portion of a second layer of the metal body to form a heated portion of the second layer;
capturing a second plurality of thermal digital images of the heated portion of the second layer;
stitching the second plurality of thermal digital images into a second stitched thermal digital image of the heated portion of the second layer;
applying a local threshold to the first stitched thermal digital image and to the second stitched thermal digital image to generate a respective first binary image and a respective second binary image;
multiplying the first binary image by the second binary image to generate a multiplied binary image; and
identifying defect areas on the multiplied binary image based on pixel intensity value.

2. The method of claim 1, further comprising: prior to multiplying, filtering the first binary image and the second binary image to remove at least a portion of noise in the first binary image and the second binary image.

3. The method of claim 1, further comprising: prior to multiplying, dilating the first binary image and the second binary image to generate a dilated first binary image and a dilated second binary image.

4. The method of claim 1, wherein stitching the plurality of thermal digital images into each respective stitched thermal digital image, comprises:
applying a global threshold to each respective thermal digital image of the plurality of thermal digital images to generate a corresponding respective binary image;
multiplying each corresponding respective binary image by the corresponding respective thermal digital image to generate a respective multiplied thermal digital image; and
adding each respective multiplied thermal digital image with a following multiplied thermal digital image to generate the stitched thermal digital image.

5. The method of claim 4, further comprising:
after generating the stitched thermal digital image, one of: replacing a greyscale value of each pixel in the stitched thermal digital image with a global average intensity value when the greyscale value of the pixel is above a global threshold value, or keeping the greyscale value of each pixel in the stitched thermal digital image when the greyscale value of the pixel is below a global threshold value.

6. The method of claim 4, further comprising: prior to applying a global threshold to generate a corresponding respective binary image, applying an averaging filter to each respective thermal digital image of the plurality of thermal digital images to remove at least a portion of noise from each respective thermal digital image.

7. The method of claim 4, further comprising: prior to multiplying each corresponding respective binary image by the corresponding respective thermal digital image, dilating each corresponding respective binary image.

8. The method of claim 7, further comprising: removing particles of a predetermined size from each corresponding respective dilated binary image.

9. The method of claim 1, further comprising: prior to applying a local threshold to the first stitched thermal digital image and to the second stitched thermal digital image, eliminating perspective distortion from each respective stitched thermal digital image.

10. The method of claim 1, wherein each of the first plurality of thermal digital images and each of the second plurality of thermal digital images is exposed for a sufficient time to capture each of the first plurality of thermal digital images and each of the second plurality of thermal digital images without saturating the respective thermal digital image.

11. The method of claim 1, wherein each of the first plurality of thermal digital images and each of the second plurality of thermal digital images is captured via a system comprising: an imaging device having a lens; a neutral density filter attached to the imaging device lens; a notch filter attached to the neutral density filter; and a near-infrared band pass filter attached to the notch filter.

12. A method, comprising:
heating at least a portion of a first layer of a metal body to form a heated portion of the first layer;
capturing a first plurality of thermal digital images of the heated portion of the first layer;
stitching the first plurality of thermal digital images into a first stitched thermal digital image of the heated portion of the first layer;
heating at least a portion of a second layer of a metal body to form a heated portion of the second layer;
capturing a second plurality of thermal digital images of the heated portion of the second layer;
stitching the second plurality of thermal digital images into a second stitched thermal digital image of the heated portion of the second layer;
applying a local threshold to the first stitched thermal digital image and to the second stitched thermal digital image to generate a respective first binary image and a respective second binary image;
filtering the first binary image and the second binary image to remove at least a portion of noise in each respective binary image to generate a first filtered binary image and a second filtered binary image;
dilating the first filtered binary image and the second filtered binary image to generate a dilated, filtered first binary image and a dilated, filtered second binary image;
multiplying the first dilated, filtered binary image by the second dilated, filtered binary image to generate a multiplied binary image; and
identifying defect areas on the multiplied binary image based on pixel intensity value.

13. The method of claim 12, wherein stitching the plurality of thermal digital images into each respective stitched thermal digital image, comprises:
applying an averaging filter to each respective thermal digital image of the plurality of thermal digital images to remove at least a portion of noise from each respective thermal digital image;
applying a global threshold to each respective thermal digital image of the plurality of thermal digital images to generate a corresponding respective binary image;
dilating each corresponding respective binary image;
removing particles of a predetermined size from each corresponding respective dilated binary image;
multiplying each corresponding respective binary image by the corresponding respective thermal digital image to generate a respective multiplied thermal digital image; and
adding each respective multiplied thermal digital image with a following multiplied thermal digital image to generate the stitched thermal digital image.

14. The method of claim 13, further comprising:
after generating the stitched thermal digital image, one of: replacing a greyscale value of each pixel in the stitched thermal digital image with a global average intensity value when the greyscale value of the pixel is above a global threshold value, or keeping the greyscale value of each pixel in the stitched thermal digital image when the greyscale value of the pixel is below a global threshold value.

15. A system for detecting defects in an additively manufactured metal part, comprising:
an imaging device having a lens; and
an image processing system configured to:
receive, from the imaging device, a first plurality of thermal digital images of a heated portion of a first layer of a metal body,
stitch the first plurality of thermal digital images into a first stitched thermal digital image of the heated portion of the first layer,
receive, from the imaging device, a second plurality of thermal digital images of a heated portion of a second layer of the metal body,
apply a local threshold to the first stitched thermal digital image and to the second stitched thermal digital image to generate a respective first binary image and a respective second binary image,
filter the first binary image and the second binary image to remove at least a portion of noise in each respective binary image to generate a first filtered binary image and a second filtered binary image,
dilate the first filtered binary image and the second filtered binary image to generate a dilated, filtered first binary image and a dilated, filtered second binary image,
multiply the first dilated, filtered binary image by the second dilated, filtered binary image to generate a multiplied binary image, and
identify defect areas on the multiplied binary image based on pixel intensity value.

16. The system of claim 15, further comprising:
a neutral density filter attached to the imaging device lens;
a notch filter attached to the neutral density filter; and
a near-infrared band pass filter attached to the notch filter.

17. The system of claim 15, wherein the image processing system is configured to stitch the plurality of thermal digital images into each respective stitched thermal digital image, via:
applying an averaging filter to each respective thermal digital image of the plurality of thermal digital images to remove at least a portion of noise from each respective thermal digital image;
applying a global threshold to each respective thermal digital image of the plurality of thermal digital images to generate a corresponding respective binary image;
dilating each corresponding respective binary image;
removing particles of a predetermined size from each corresponding respective dilated binary image;
multiplying each corresponding respective binary image by the corresponding respective thermal digital image to generate a respective multiplied thermal digital image; and
adding each respective multiplied thermal digital image with a following multiplied thermal digital image to generate the stitched thermal digital image.
